(19) United States
(12) Patent Application Publication
(10) Pub. No.: US 2015/0198059 A1
(43) Pub. Date: Jul. 16, 2015

(54) GAS TURBINE MANUAL CLEANING AND PASSIVATION

(71) Applicant: General Electric Company, Schenectady, NY (US)

(72) Inventors: Alston Ilford Scipio, Mableton, GA (US); Sanji Ekanayake, Mableton, GA (US); Stephen Paul Wassynger, Simpsonville, SC (US)

(73) Assignee: General Electric Company, Schenectady, NY (US)

(21) Appl. No.: 14/152,103

(22) Filed: Jan. 10, 2014

(51) Int. Cl. F01D 25/00; B08B 5/02; B08B 1/00; B08B 7/04; B08B 3/08

(52) U.S. Cl. CPC F01D 25/002; B08B 7/04; B08B 3/08; B08B 1/001; B08B 5/02

(57) ABSTRACT

A gas turbine engine may be manually cleaned by removing a compressor casing and a turbine casing from the gas turbine engine, cleaning stator vanes of the gas turbine engine, and applying an organic acid solution to metallic surfaces of the gas turbine engine. The organic acid solution may be rinsed from the gas turbine engine and an anticorrosive solution may be applied to the metallic surfaces of the gas turbine engine.

### BACKGROUND

Gas turbines, which may also be referred to as combustion turbines, are internal combustion engines that pressurize air and add heat to the air by combusting fuel in a chamber to increase the temperature of the gases that make up the air, expanding the gases. The gases are then directed towards a turbine to extract the energy generated by the hot, expanded gases. Gas turbines have many practical applications, including use as jet engines and in industrial power generation systems. Gas turbines are exposed to a variety of atmospheric and environmental factors during normal operation. While most stationary gas turbines are equipped with an inlet air filtration system, it is not possible to prevent all atmospheric and environmental contaminants from entering the turbine.

Because atmospheric and environmental contaminants enters a gas turbine despite filtering of incoming air, turbine components become fouled over time by such airborne contaminants. To address this fouling, gas turbine components may be cleaned or “washed” offline (i.e., when not in operation) and online (i.e., while operating). Offline washing may take the form of an automated process performed using mechanical devices to inject cleaning and rinsing solutions. Offline washing may also be performed manually with maintenance personnel cleaning turbine components, injecting or applying cleaning and rinsing solutions, and performing other aspects of the washing process.

Even when performing turbine washes regularly, some fouling may remain on the components of a gas turbine, for example, a residue of the cleaning fluids used to wash the gas turbine may accumulate on turbine components. Rust may also appear on components of a gas turbine. The lack of complete cleaning by wash processes may be due to various factors, including the limited reach of wash detergents to higher numbered compressor stages of a gas turbine resulting in these stages being less thoroughly washed, inadequate rinsing during the wash process leaving residual detergents, and unreliable detergent nozzle distribution and coverage. Rust may begin to appear due to inadequate rinsing and drying of the turbine following a wash process.

### BRIEF DESCRIPTION OF THE INVENTION

In an exemplary non-limiting embodiment, a method is disclosed for manual gas turbine engine cleaning. The gas turbine engine may be cleaned by removing a compressor casing and a turbine casing from the gas turbine engine, cleaning stator vanes of the gas turbine engine, and applying an organic acid solution to metallic surfaces of the gas turbine engine. The organic acid solution may be rinsed from the gas turbine engine and an anticorrosive solution may be applied to the metallic surfaces of the gas turbine engine.

In another exemplary non-limiting embodiment, another method is disclosed for manual gas turbine engine cleaning. The gas turbine engine may be cleaned by removing a compressor casing and a turbine casing from the gas turbine engine, cleaning stator vanes of the gas turbine engine, and applying a citric acid solution to metallic surfaces of the gas turbine engine. The citric acid solution may be rinsed from the gas turbine engine and an anticorrosive solution may be applied to the metallic surfaces of the gas turbine engine.

In another exemplary non-limiting embodiment, another method is disclosed for manual gas turbine engine cleaning. The gas turbine engine may be cleaned by removing a compressor casing and a turbine casing from the gas turbine engine, cleaning stator vanes of the gas turbine engine, and applying an peracetic acid solution to metallic surfaces of the gas turbine engine. The peracetic acid solution may be rinsed from the gas turbine engine and an anticorrosive solution may be applied to the metallic surfaces of the gas turbine engine.

The foregoing summary, as well as the following detailed description, is better understood when read in conjunction with the drawings. For the purpose of illustrating the claimed subject matter, there is shown in the drawings examples that illustrate various embodiments; however, the invention is not limited to the specific systems and methods disclosed.

### BRIEF DESCRIPTION OF THE DRAWINGS

These and other features, aspects, and advantages of the present subject matter will become better understood when the following detailed description is read with reference to the accompanying drawings, wherein:

FIG. 1 is an illustration of an exemplary non-limiting gas turbine system;

FIG. 2 is another illustration of an exemplary non-limiting turbine system;

FIG. 3 illustrates a non-limiting, exemplary method of performing a manual wash of a gas turbine; and

FIG. 4 illustrates a non-limiting, exemplary method of performing a manual wash of a gas turbine.

### DETAILED DESCRIPTION OF THE INVENTION

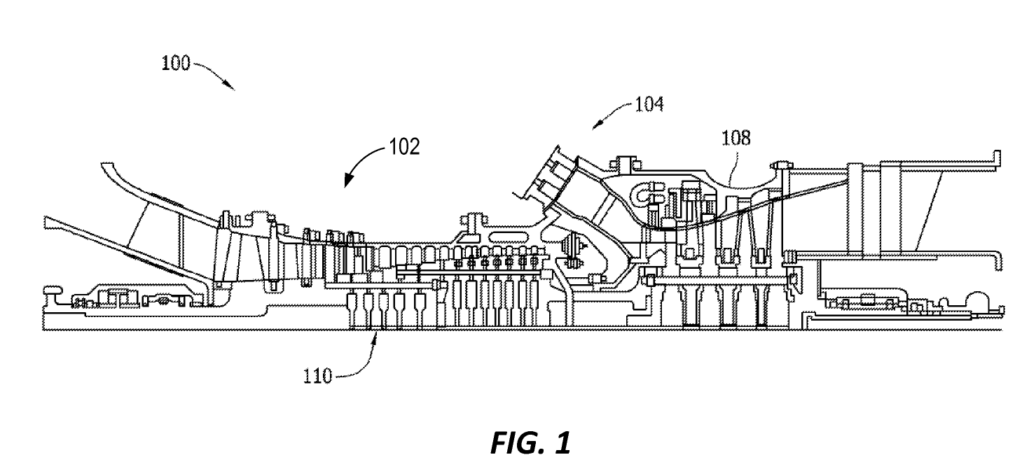

FIG. 1 is a schematic illustration of an exemplary non-limiting gas turbine engine 100. Engine 100 may include a compressor section 102 and a combustor system 104. Engine 100 may also include a turbine section 108 and a common compressor/turbine shaft 110 (may also be referred to as rotor 110).

In operation, air may flow through compressor section 102 such that compressed air is supplied to combustor system 104. Fuel may be channeled to a combustion region and/or zone (not shown) that is defined within combustor system 104 where the fuel may be mixed with the air and ignited. Combustion gases generated are channeled to turbine section 108 where gas stream thermal energy is converted to mechanical rotational energy. Turbine section 108 is rotatably coupled to shaft 110. It should also be appreciated that the term “fluid” as used herein includes any medium or material that flows, including, but not limited to, gas and air.

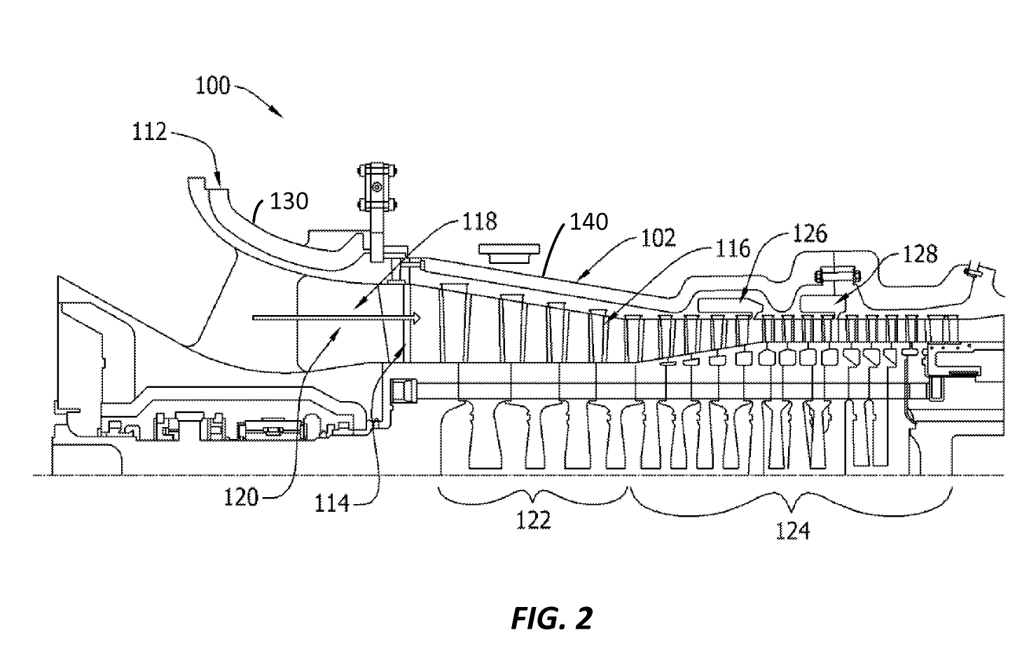

FIG. 2 is a schematic illustration of a non-limiting exemplary compressor section of exemplary turbine engine 100. Engine 100 may further include compressor bellmouth 112, inlet casing 130, compressor blades 114, compressor casing 140, and compressor stator vanes 116. Typical gas turbine washing methods may involve the placement 118 of water wash nozzles (not shown), such that wash water follows a generally axial path 120 through compressor 102. Using such washing methods may result in effective cleaning only through first seven (or fewer) stages 122 of compressor 102, with latter stages 124 of compressor 102 not receiving adequate cleaning. Entry points 126 and 128 indicate entry points for the introduction of water, cleaning agents, or a mixture of water and one or more cleaning agents into the ninth (9th) stage and the thirteenth (13th) stages, respectively, of compressor 102. However, such cleaning may still leave deposits and other contaminants within turbine engine 100, therefore necessitating manual cleaning of turbine engine 100.

After a period of sustained operation turbine engine performance may deteriorate, resulting in reduced output and lower thermal efficiency, often due to compressor fouling. Compressor fouling may include a buildup of foreign matter (e.g., dust, oils, dirt) on the compressor's rotating and stationary parts as a result of the turbine engine ingesting various airborne contaminants, including hydrocarbon based materials and small charged particles. To remove fouling materials and recover some percentage of lost performance, periodic on-line and off-line water washing of a gas turbine's compressor may be performed.

Automated online water washing may be performed by injecting demineralized water into the compressor while the turbine engine is operating at a predetermined power output. Automated offline water washing may be performed by injecting a predetermined cleaning solution, for example a blend of demineralized water and a detergent, into a compressor bellmouth (e.g., compressor bellmouth 112) using an arrangement of nozzles designed to produce a particular spray pattern. After a predetermined agitation period and discharge of the wash water, demineralized water may be injected into the turbine engine for rinsing. After draining of the rinse water and a period of drying, a typical online wash may be complete.

Visual inspections of turbine engines during maintenance and immediately after automated washing often show that there is limited cleaning of the higher numbered compressor stages, where, for example, compressor stages 0 through 6 may be very clean, stages 6 through 10 may show reduced cleaning when compared to stages 0 through 6, stages 10 through 17 show relative little sign of cleaning. Moreover, inadequate rinsing may be observed, as evidenced by residual soap in the compressor. The wash systems often used may also be adjusted with different goals than optimal cleaning, for example to save water or detergent or to reduce water wash duration. The wash systems may also deteriorate over time, for example, detergent distributing nozzles may become plugged or restricted by debris, inhibiting proper detergent and rinse water flow. Proper draining may be inhibited due to plugged, restricted, or misaligned drainage system components, malfunctioning valves, inadequate drains, or inadequate drainage system designs, resulting in water retention in a compressor section and/or migration of water into a combustor section. As a result of less effective cleaning, visible pitting and impact damage to blades and vanes may often be found.

To address these shortcomings of automatic cleaning and further mitigate against the need to replace compressor and other turbine engine components, a turbine engine may be removed from service, opened, and cleaned by hand. Such manual cleaning may include cleaning of compressor blades, vanes, and other components along the internal flow path of the turbine engine. By using embodiments set forth herein, compressor flow path components may be more comprehensively cleaned and additional performance may be recovered due to the removal of accumulated deposits, contaminants, and rust from the blades and casings of the turbine engine. The rate of compressor component corrosion may be mitigated by using surface passivation as set forth herein. The embodiments set forth herein may also be used to prepare a turbine engine for an extended period of inactivity.

To mitigate the rate of corrosion and other damage, blending, polishing, and grinding may be performed when a turbine engine is take out of service. However, these approaches may not mitigate or resurface areas having pits and craters, which in most instances if left untreated can lead to crack prorogation and accelerated corrosion. Therefore, in some embodiment passivation may be used, which may make a metallic alloy less vulnerable to damage from environmental factors. In an embodiment, a predetermined combination of water based chemicals with the disclosed treatment methods may provide a microcoating on turbine engine component surfaces that may form a shielding outer layer that inhibits deeper corrosion when the metal of the component is exposed to a corrosive environment. By causing a light coat of material (e.g., metal oxide) to be form a shell against corrosion on the treated surface, passivation may strengthen and preserve the appearance of the treated metallic surface.

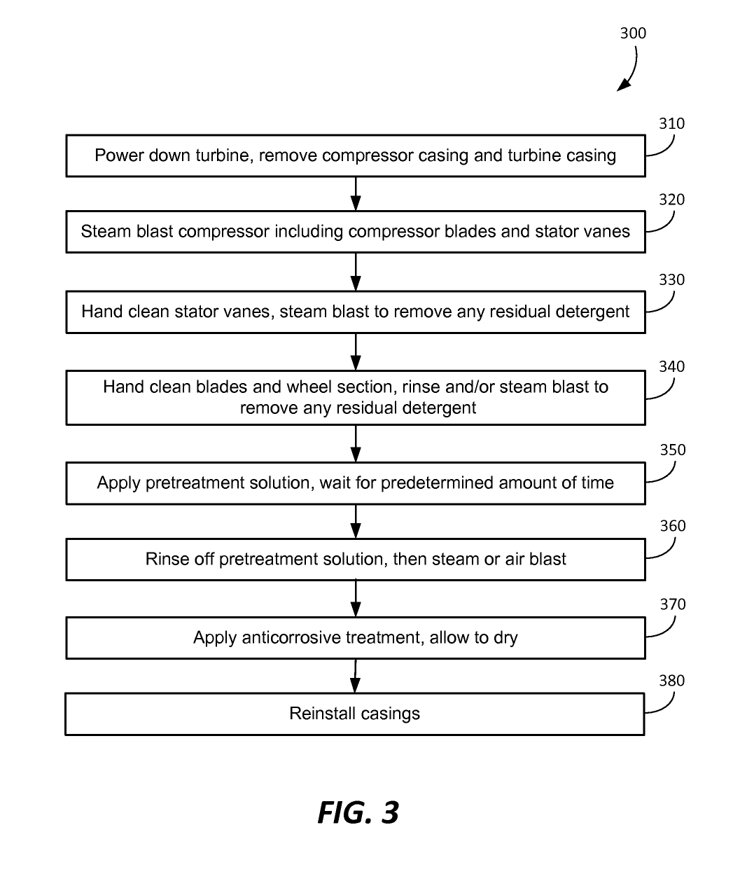

In an embodiment, referring now to method 300 of FIG. 3, a manual turbine engine cleaning may be performed during a hot gas path inspection outage with the turbine's rotor in place. Note that the functions and operations described in regard to FIG. 3 and any other methods set forth herein may be performed in any order, and any subset of such functions and operations or any individual function or operation may be performed in isolation or in combination with any other functions and operations described herein or not described herein. All such embodiments are contemplated as within the scope of the present disclosure.

At block 310, a gas turbine may be powered down or otherwise placed in an offline condition and its compressor casing (e.g., compressor casing 140 of FIG. 2) and turbine casings may be removed. At block 320, the turbine engine's compressor blades (e.g. compressor blades 114) and/or stator vanes (e.g., compressor stator vanes 116) may be steam blasted, using one or more manual steam blasting devices, to remove oil, grease, and other hydrocarbon related deposits. At block 330, stator vanes in the upper half of the turbine engine may be hand cleaned, in an embodiment using a combination of detergent and a hand held abrasive pad (e.g., steel wool pad.) Also at block 330, after the vanes are hand cleaned, steam may be used to remove any residual detergent

At block 340, compressor blades and wheel sections of the turbine engine may be hand cleaned, in an embodiment using a combination of detergent and a hand held abrasive pad (e.g., steel wool pad) and angular rotation of the shaft line as needed to facilitate total access. After all blades are hand cleaned, water rinsing and/or steam blasting may be used to remove any residual detergent and to ensure no debris has migrated into critical cooling openings.

At block 350, a precursor or pretreatment solution for a subsequent anticorrosive application may be applied using one or more manual spray devices. This may be one of several contemplated precursor treatments. In an embodiment, an organic acid blend may be used at block 350 that is a predetermined organic acid blend of peracetic acid and citric acid, with an ammonium hydroxide activator and demineralized water. Alternatively, the pretreatment solution may include only one of peracetic acid and citric acid. The applied pretreatment solution may remove any residual fouling, detergents, and rust deposits prior to the application of anti-corrosive treatment. The pretreatment may be left applied to the turbine engine components for a predetermined amount of time. At block 360, demineralized water may be used to rinse off the pretreatment solution followed by steam or compressed air blasting to remove any residual solution from tight recesses and fittings. At block 370, an anticorrosive treatment may be applied to all pretreated surfaces using one or more manual spray devices and allowed to dry. At block 380, the casings may be reinstalled. The turbine may then be returned to service or stored.

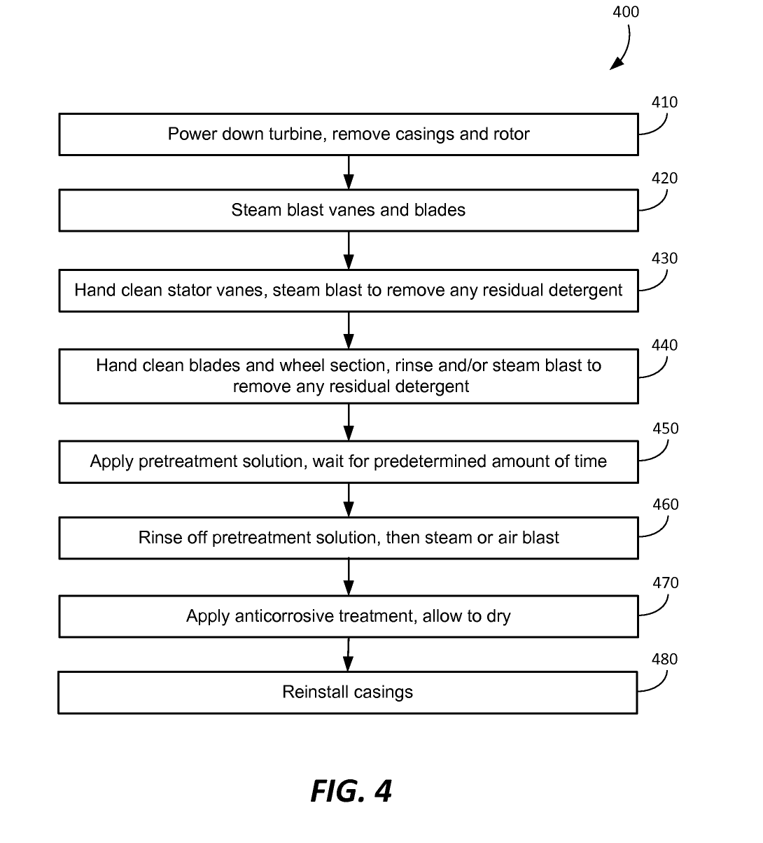

In an embodiment, and referring now to method 400 of FIG. 4, a manual turbine engine cleaning may be performed with the turbine's rotor removed. At block 410, a gas turbine may be powered down or otherwise placed in an offline condition and its compressor casing (e.g., compressor casing 140 of FIG. 2), turbine casing, and rotor (e.g., rotor 110 of FIG. 1) may be removed. At block 420, the turbine engine's stator vanes (e.g., compressor stator vanes 116) and the blades of the removed rotor may be steam blasted, using one or more manual steam blasting devices, to remove oil, grease, and other hydrocarbon related deposits. At block 430, stator vanes in both the upper half and the lower half of the turbine engine casing may be hand cleaned, in an embodiment using a combination of detergent and a hand held abrasive pad (e.g., steel wool pad.) Also at block 430, after the stator vanes are hand cleaned, steam may be used to remove any residual detergent

At block 440, with the removed rotor placed on a support stand, compressor blades and wheel sections of the turbine engine may be hand cleaned, in an embodiment using a combination of detergent and a hand held abrasive pad (e.g., steel wool pad) and angular rotation of the shaft line as needed to facilitate total access. After all blades are hand cleaned, water rinsing and/or steam blasting may be used to remove any residual detergent and to ensure no debris has migrated into critical cooling openings.

At block 450, a precursor or pretreatment solution for a subsequent anticorrosive application may be applied to all metallic surfaces using one or more manual spray devices. This may be one of several contemplated precursor treatments. In an embodiment, an organic acid blend may be used at block 450 that is a predetermined blend of peracetic acid, citric acid, and demineralized water. Alternatively, the pretreatment solution may be a peracetic acid and demineralized water blend. In yet another alternative, the pretreatment solution may be a citric acid and demineralized water blend. Any of these blends may also include an ammonium hydroxide activator. The applied pretreatment solution may remove any residual fouling, detergents, and rust deposits prior to the application of anti-corrosive treatment. The pretreatment may be left applied to the turbine engine components for a predetermined amount of time. At block 460, demineralized water may be used to rinse off the pretreatment solution followed by steam or compressed air blasting to remove any residual solution from tight recesses and fittings. At block 470, an anticorrosive treatment may be applied to all pretreated surfaces using one or more manual spray devices and allowed to dry. At block 480, the turbine engine may be reassembled. The turbine may then be returned to service or stored.

The anticorrosive solution used may be any solution that may help inhibit corrosion of the components of the gas turbine. In an embodiment, the anticorrosive solution may be a polyamine solution or may contain a polyamine compound. As used herein, the term “polyamine” is used to refer to an organic compound having two or more primary amino groups such as NH₂. In another embodiment, the anticorrosive solution may include a volatile neutralizing amine that may neutralize acidic contaminants and elevate the pH into an alkaline range, and with which protective metal oxide coatings are particularly stable and adherent. Nonlimiting examples of the anticorrosion agents that may be used in such a solution include cycloheaxylamine, morpholine, monoethanolamine, N-9-octadecenyl-1,3-propanediamine, 9-octadecen-1-amine, (Z)-1-5, dimethylaminepropylamine (DMPA), diethylaminoethanol (DEAE), and the like, and any combination thereof

The technical effect of the systems and methods set forth herein is the improved distribution and coverage of anticorrosive solution by ensuring that a gas turbine is more thoroughly cleaned before application of the anticorrosive solution. Better cleaning of gas turbine components using the disclosed systems and methods will also help maintain recovered performance for longer duration, improve gas turbine performance, efficiency, and lifespan, as will be appreciated by those skilled in the art. Use of the disclosed organic acid blends in a manual cleaning process before application of an anticorrosive solution may remove fouling, residual detergent, and rust deposits and passivate internal compressor metallic surfaces, as well as improve the surface adsorption potential for the anticorrosive solution application. Those skilled in the art will recognize that the disclosed systems and methods may be combined with other systems and technologies in order to achieve even greater gas turbine cleanliness, performance, and efficiency. All such embodiments are contemplated as within the scope of the present disclosure.

This written description uses examples to disclose the subject matter contained herein, including the best mode, and also to enable any person skilled in the art to practice the invention, including making and using any devices or systems and performing any incorporated methods. The patentable scope of this disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for manually cleaning a gas turbine engine, the method comprising:
removing a compressor casing and a turbine casing from the gas turbine engine;
cleaning stator vanes of the gas turbine engine;
applying an organic acid solution to metallic surfaces of the gas turbine engine;
rinsing the organic acid solution from the gas turbine engine; and
applying an anticorrosive solution to the metallic surfaces of the gas turbine engine.

2. The method of claim 1, further comprising removing a rotor from the gas turbine engine.

3. The method of claim 1, wherein cleaning the stator vanes of the gas turbine engine comprises steam blasting the stator vanes of the gas turbine engine.

4. The method of claim 1, wherein cleaning the stator vanes of the gas turbine engine comprises hand cleaning the stator vanes of the gas turbine engine using an abrasive pad.

5. The method of claim 1, further comprising cleaning compressor blades and wheel sections of the gas turbine engine.

6. The method of claim 5, wherein cleaning the compressor blades and the wheel sections of the gas turbine engine comprises hand cleaning the compressor blades and the wheel sections of the gas turbine engine using an abrasive pad.

7. The method of claim 5, further comprising rinsing the compressor blades and the wheel sections of the gas turbine engine.

8. A method for manually cleaning a gas turbine engine, the method comprising:
removing a compressor casing and a turbine casing from the gas turbine engine;
cleaning stator vanes of the gas turbine engine;
applying a citric acid solution to metallic surfaces of the gas turbine engine;
rinsing the citric acid solution from the gas turbine engine; and
applying an anticorrosive solution to the metallic surfaces of the gas turbine engine.

9. The method of claim 8, further comprising removing a rotor from the gas turbine engine.

10. The method of claim 8, wherein cleaning the stator vanes of the gas turbine engine comprises steam blasting the stator vanes of the gas turbine engine.

11. The method of claim 8, wherein cleaning the stator vanes of the gas turbine engine comprises hand cleaning the stator vanes of the gas turbine engine using an abrasive pad.

12. The method of claim 8, further comprising cleaning compressor blades and wheel sections of the gas turbine engine.

13. The method of claim 12, wherein cleaning the compressor blades and the wheel sections of the gas turbine engine comprises hand cleaning the compressor blades and the wheel sections of the gas turbine engine using an abrasive pad.

14. The method of claim 12, further comprising rinsing the compressor blades and the wheel sections of the gas turbine engine.

15. A method for manually cleaning a gas turbine engine, the method comprising:
removing a compressor casing and a turbine casing from the gas turbine engine;
cleaning stator vanes of the gas turbine engine;
applying a peracetic acid solution to metallic surfaces of the gas turbine engine;
rinsing the peracetic acid solution from the gas turbine engine; and
applying an anticorrosive solution to the metallic surfaces of the gas turbine engine.

16. The method of claim 15, further comprising removing a rotor from the gas turbine engine.

17. The method of claim 15, wherein cleaning the stator vanes of the gas turbine engine comprises steam blasting the stator vanes of the gas turbine engine.

18. The method of claim 15, wherein cleaning the stator vanes of the gas turbine engine comprises hand cleaning the stator vanes of the gas turbine engine using an abrasive pad.

19. The method of claim 15, further comprising cleaning compressor blades and wheel sections of the gas turbine engine.

20. The method of claim 19, wherein cleaning the compressor blades and the wheel sections of the gas turbine engine comprises hand cleaning the compressor blades and the wheel sections of the gas turbine engine using an abrasive pad.
